(19) United States
(12) Patent Application Publication
(10) Pub. No.: US 2026/0327777 A1
(43) Pub. Date: Oct. 22, 2026

(54) PREPARATION METHOD FOR ELECTRICAL STEEL WITH HIGH MAGNETIC INDUCTION, LOW IRON LOSS AND GRADIENT DISTRIBUTION OF SILICON

(71) Applicant: NORTHEASTERN UNIVERSITY, Shenyang (CN)

(72) Inventors: Zhenyu LIU, Shenyang (CN); Yuqi MAO, Shenyang (CN); Chenggang LI, Shenyang (CN)

(21) Appl. No.: 19/652,180

(22) Filed: Apr. 20, 2026

(30) Foreign Application Priority Data
Apr. 21, 2025 (CN) 202510494492.2

(51) Int. Cl. C23C 10/06; C23C 10/60; H01F 1/147

(52) U.S. Cl. CPC C23C 10/06; C23C 10/60; H01F 1/14775; H01F 1/14791

(57) ABSTRACT

Provided is a preparation method for an electrical steel with high magnetic induction, low iron loss and gradient distribution of silicon. Siliconizing treatment is performed at a temperature of 1050 °C-1200 °C for 5 min-60 min; an iron matrix of the strip steel during the siliconizing process exhibits a face-centered cubic structure, the face-centered cubic structure enables a silicon content on the surface and in the core of the strip steel to exhibit a significant gradient distribution; after the siliconizing treatment, diffusion annealing treatment is performed at a temperature of 980 °C-1200 °C for 5 min-20 min; and the strip steel after the siliconizing treatment has a surface silicon content of 2.5 wt. %-7.5 wt. % and a core silicon content of 0.1 wt. %-2.0 wt. %, thereby obtaining the electrical steel with high magnetic induction, low iron loss and gradient distribution of silicon.

### BACKGROUND OF THE INVENTION

### 1. Field of the Invention

The present invention relates to the technical field of electrical steel preparation, and particularly relates to a preparation method for an electrical steel with high magnetic induction, low iron loss and gradient distribution of silicon.

### 2. The Prior Arts

Electrical steel (also known as silicon steel) is a widely applied soft magnetic material, extensively applied in apparatuses such as transformers, motors, and generators. The properties mainly depend on magnetic induction intensity, iron loss, and the microstructure of the material. In the prior art, the main means for improving the properties of the electrical steel include optimization of chemical compositions, improvement of heat treatment processes, and regulation of a silicon content. In particular, silicon plays a crucial role in the electrical steel, because it can effectively increase electrical resistivity, reduce the iron loss, and enhance the magnetic properties of the material. However, materials with a high silicon content are prone to embrittlement during processing, and traditional metallurgical and cold rolling processes are difficult to simultaneously meet the requirements of the electrical steel for a high silicon content and excellent mechanical properties. High-silicon steel, particularly steel with a silicon content exceeding 2 wt. %, due to its excellent soft magnetic properties, including high magnetic induction intensity and low iron loss, is widely applied in electromagnetic apparatuses such as motors and transformers. However, as the silicon content increases, the brittleness of the steel also increases significantly, leading to processing difficulties and unstable properties.

Currently, main methods for preparing the high-silicon steel include a chemical vapor deposition (CVD) method, an electron beam physical vapor deposition (EB-PVD) method, a molten salt electrodeposition method, etc. Among the available methods, chemical vapor deposition (CVD) has become one of the principal technologies for fabricating high-silicon steel thin strips with a silicon content of 6.5 wt. %, because of its process maturity and relatively low cost. However, the conventional CVD process is typically performed at high temperatures, and the siliconizing reaction is relatively intense, causing a large amount of silicon to penetrate from the surface to the core, thereby affecting the properties of the strip steel.

Chinese patent publication No. 107923029 A proposes a technology for preparing high-silicon electrical steel by a vapor-phase siliconizing method. In the method, a vapor-phase siliconizing material is used in a vacuum environment to enable silicon to uniformly infiltrate into the steel, thereby significantly improving the magnetic properties of the steel. However, the method has the problems of intense reaction and difficulty in controlling the silicon content at the center of the strip steel in industrial applications. Chinese patent publication No. 105296917 A adopts a solid powder siliconizing method, in which siliconizing powder is applied onto the surface of the steel to achieve diffusion and penetration of the silicon at high temperature. The method is suitable for industrial production, but has certain limitations in controlling the gradient of a silicon content.

Chinese patent publication No. 115478135 A and Chinese patent publication No. 112410672 A both propose methods for preparing high-silicon steel thin strips by CVD. However, the steel compositions determine that siliconizing in these two patents occurs in a ferrite phase state. At the siliconizing stage, the silicon diffusion rate is very high, making it difficult to achieve precise control over the gradient distribution of silicon concentration. It is also difficult to form a significant gradient distribution of silicon concentration between the surface layer and the core of the strip steel. The siliconizing depth substantially involves the entire thickness range of the strip steel, resulting in a very small difference in the silicon concentration between the surface layer and the core. The increase in the silicon content at the core is larger compared to the concentration of original base strip steel, mostly exceeding 3.0 wt. %.

Although existing methods can improve the properties of the electrical steel to a certain extent, they still have limitations in controlling brittle phases in high-silicon steel. Furthermore, studies have indicated that the brittleness of 6.5 wt. % silicon steel may be primarily associated with ordered intermetallic compounds in alloy, such as B₂ and DO₃ phases. The presence of the brittle phases severely affects plasticity and toughness of the material.

### SUMMARY OF THE INVENTION

Conventional high-silicon electrical steel tends to exhibit increased material brittleness due to a relatively high silicon content, which increases processing difficulty and limits its large-scale industrial application. In addition, existing siliconizing processes lack sufficient control over the gradient of the silicon content, and are unable to simultaneously achieve high magnetic induction at the surface and high mechanical properties in the core. To address the above problems, the present invention provides a method for preparing high-performance electrical steel having a gradient silicon distribution.

A preparation method for an electrical steel with high magnetic induction, low iron loss and gradient distribution of silicon according to the present invention includes the following steps:

Siliconizing treatment is performed on a strip steel. By controlling the compositions of the strip steel, the iron matrix of the strip steel exhibits a face-centered cubic (FCC) structure during the siliconizing process. The face-centered cubic structure enables the silicon content at the surface and in the core of the strip steel to form a significant gradient distribution. After the siliconizing treatment, the strip steel has a surface silicon content of 2.5 wt. %-7.5 wt. % and a core silicon content of 0.1 wt. %-2.0 wt. %, thereby providing electrical steel having high magnetic induction, low iron loss and a gradient silicon distribution.

The strip steel includes the following main components by mass percentage: 0.5 wt. %-2.0 wt. % of Si+Al, with Si not being 0, 0.001 wt. %-0.005 wt. % of C; 0.01 wt. %-0.5 wt. % of Mn, and the balance being Fe.

When a thickness of the strip steel satisfies required dimensions, the siliconizing treatment is performed directly. When the thickness of the strip steel is greater than the required dimensions, the strip steel is first to cold rolling to achieve the required dimensions, followed by the siliconizing treatment.

Preferably, when the thickness of the strip steel is 0.08 mm-0.5 mm, the strip steel is directly subjected to the siliconizing treatment. When the thickness of the strip steel is greater than 0.5 mm, the strip steel is first subjected to cold rolling to achieve the required dimensions, followed by the siliconizing treatment.

Preferably, a cold rolling reduction is greater than or equal to 85%.

Preferably, the siliconizing treatment is performed at a temperature of 1050 °C-1200 °C for 5 min-60 min.

Preferably, the siliconizing treatment uses SiCl₄ as a silicon source. During the siliconizing process, a concentration of SiCl₄ vapor is 15%-30%, and argon is used as a carrier gas.

Preferably, during the siliconizing process, a unit tension of 1 N/m²-5 N/m² is applied to the strip steel.

Preferably, after the strip steel is subjected to the siliconizing treatment, the strip steel is further subjected to a diffusion annealing treatment, thereby providing electrical steel have high magnetic induction, low iron loss and a gradient silicon distribution.

Preferably, the diffusion annealing treatment is performed at a temperature of 980 °C-1200 °C for 5 min-20 min.

Preferably, the entire annealing course is performed in a non-oxidizing atmosphere, and nitrogen and argon are used as protective gases.

Before the siliconizing treatment, an original low-carbon, low-silicon strip steel is subjected to cold rolling treatment, thereby enabling the strip steel to develop favorable magnetic properties and providing a favorable microstructure foundation and surface quality for the subsequent siliconizing process. By optimizing the compositions of the strip steel and the siliconizing process, an iron matrix of the strip steel exhibits a face-centered cubic (FCC) structure during the siliconizing process. Compared with a body-centered cubic (BCC) structure, the face-centered cubic (FCC) structure has a higher density, making silicon more stable during penetration and siliconizing reaction less intense than that in the body-centered cubic structure. As a result, silicon can only penetrate into the surface of the strip steel, while silicon penetration into the core is restricted. During the siliconizing process, a unit tension of 1 N/m²-5 N/m² is applied to the strip steel to prevent warping or stress concentration at the surface of the strip steel, thereby ensuring the quality of siliconizing treatment and the shape stability of the strip steel.

Diffusion annealing after the siliconizing treatment can further optimize the gradient distribution of the silicon content. As a result, the strip steel has a surface silicon content of 2.5 wt. %-7.5 wt. %, which can increase the magnetic induction intensity and reduce iron loss. Meanwhile, the silicon content in the core is maintained at 0.1 wt. %-2.0 wt. %, thereby improving the grain orientation and microstructural uniformity of the steel and enhancing both the magnetic and mechanical properties of the electrical steel. The thickness of the high-performance electrical steel product prepared by the present invention is controlled within the range of 0.08 mm-0.5 mm, making it suitable for a variety of high-efficiency electromagnetic apparatuses.

The beneficial effects of the present invention are as follows:
1. Balancing high magnetic induction and low iron loss: a relatively high silicon content at the surface enhances the magnetic properties of the material, while the low silicon content in the core maintains favorable mechanical properties. The magnetic induction intensity (B₅₀) can reach 1.78 T, and the iron loss can be reduced to 0.7 W/kg, thereby enabling the material to have characteristics of high magnetic induction and low iron loss.
2. Gradient distribution design: the gradient distribution of the silicon content is achieved through the siliconizing process and the diffusion annealing process. The high silicon content (2.5 wt. %-7.5 wt. %) on the surface enhances the magnetic properties, while the low silicon content (0.1 wt. %-2.0 wt. %) in the core ensures favorable mechanical properties and toughness. As a result, property matching between the surface and the core is optimized, and the overall properties of the electrical steel are significantly improved.
3. Efficient siliconizing process: the combination of rapid heating and tension control during the siliconizing process improves the silicon diffusion efficiency and effectively avoids the problems of warping and uneven quality present in conventional processes.
4. Low brittleness: through the control of the face-centered cubic (FCC) structure, the siliconizing reaction is more stable, thereby preventing excessive silicon penetration into the core and achieving the gradient distribution with high silicon at the surface and low silicon in the core. As a result, the formation of brittle phases such as B₂ and DO₃ is suppressed, and plasticity and toughness of the material are significantly improved. Accordingly, problems associated with traditional high-silicon electrical steel, such as embrittlement, high iron loss, and poor processing properties, are effectively addressed, and the overall properties of the electrical steel are significantly improved.
5. Industrial production adaptability: the present invention, by optimizing process parameters of cold rolling, siliconizing and diffusion annealing, forms a technical route suitable for large-scale batch production, having good economic efficiency and practicality.

The preparation method of the present invention has high efficiency, stability, and operability, significantly improving the properties and application range of gradient high-silicon electrical steel. The prepared gradient high-silicon electrical steel thin strip is suitable for electromagnetic apparatuses requiring high efficiency and low iron loss, such as transformer cores, motor rotors, and generator stators, and has broad application prospects particularly in the fields of new energy power apparatuses, high-efficiency motors, and low-loss transformers.

### BRIEF DESCRIPTION OF DRAWINGS

FIG. 1 is a schematic diagram of siliconizing paths when a matrix of strip steel is in a body-centered cubic (BCC) structure and a face-centered cubic (FCC) structure during siliconizing;

FIG. 2 is a diagram showing silicon content distribution of strip steel after siliconizing in Embodiment 4;

FIG. 3 is a diagram showing silicon content distribution of strip steel after siliconizing in Comparative Embodiment 1; and

FIG. 4 is a schematic diagram showing the trend of silicon content distribution of strip steel after siliconizing according to a body-centered cubic (BCC) structure and a face-centered cubic (FCC) structure.

### DETAILED DESCRIPTION OF THE PREFERRED EMBODIMENT

The technical solutions of the present invention will be described clearly and completely below in conjunction with the embodiments and the accompanying drawings. It should be noted that the embodiments described herein are intended to further explain and illustrate the present invention, rather than to limit the scope of application. Based on the present invention, all other embodiments obtained by persons of ordinary skill in the art without making creative efforts fall within the protection scope of the present invention.

### Embodiment 1

Original strip steel includes the following main components by mass percentage: 0.5 wt. % of Si+Al, with Si not being 0; 0.003 wt. % of C; 0.01 wt. % of Mn; and the balance being Fe. After cold rolling, original low-carbon low-silicon strip steel is made into strip steel with a thickness of 0.20 mm, with a cold rolling reduction of 85%, ensuring surface smoothness and thickness uniformity of the strip steel.

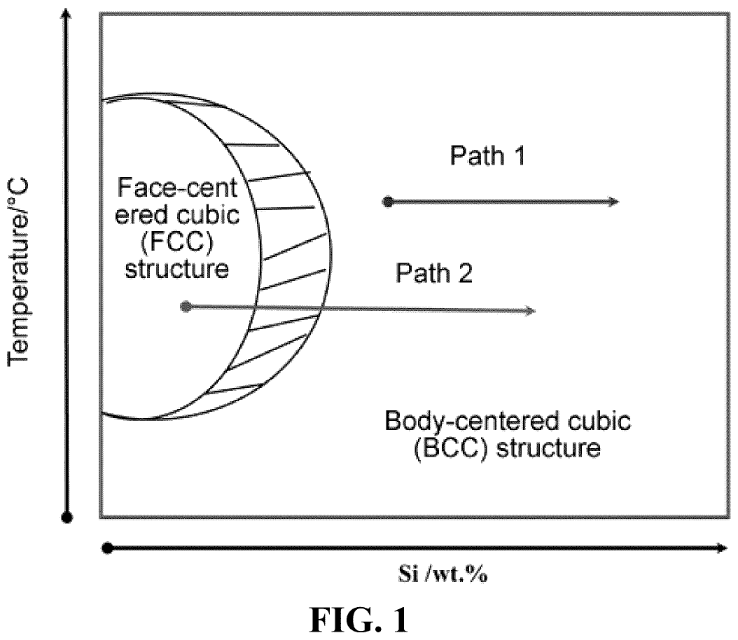

The strip steel after cold rolling is rapidly heated to 1100 °C subjected to a siliconizing treatment. During the siliconizing at this temperature, an iron matrix of the strip steel exhibits a face-centered cubic structure. Under a condition corresponding to path 2 shown in FIG. 1, the strip steel is subjected to siliconizing treatment using SiCl₄ as a silicon source and argon as a carrier gas. During the siliconizing process, SiCl₄ concentration is controlled at 20%, and siliconizing time is 15 min. In addition, during the siliconizing process, a unit tension of 3 N/m² is applied to the strip steel to ensure a flat surface of the strip steel and avoid warping or deformation.

The siliconized strip steel is placed in an annealing furnace and subjected to diffusion annealing treatment at 1000 °C for 15 min, and nitrogen is used as a protective gas. The diffusion annealing treatment further optimizes the gradient distribution of silicon in the strip steel, improves the grain structure of materials, and reduces the resistance of magnetic domain walls.

The annealed strip steel is cooled and then detected. The detection results are as follows: composition detection of the strip steel on the surface and in the core using a field emission electron probe gives a surface silicon content of 3.1 wt. % and a core silicon content of 0.5 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.78 T, and the iron loss (P_{10/50}) is 1.5 W/kg. From the surface silicon content and the core silicon content, it can be seen that a significant gradient distribution of silicon is formed between the surface and the core of the strip steel, thereby obtaining electrical steel with high magnetic induction, low iron loss and gradient distribution of silicon on the surface and in the core.

### Embodiment 2

Original strip steel includes the following main components by mass percentage: 1.0 wt. % of Si+Al, with Si not being 0; 0.002 wt. % of C; 0.2 wt. % of Mn; and the balance being Fe. After cold rolling, original low-carbon low-silicon strip steel is made into strip steel with a thickness of 0.20 mm, with a cold rolling reduction of 90%, ensuring that the strip steel has good microstructural uniformity and processing properties.

The strip steel after cold rolling is rapidly heated to 1200 °C subjected to a siliconizing treatment. During the siliconizing at this temperature, an iron matrix of the strip steel exhibits a face-centered cubic structure. Under a condition corresponding to path 2 shown in FIG. 1, the strip steel is subjected to siliconizing treatment using SiCl₄ as a silicon source and argon as a carrier gas. During the siliconizing process, SiCl₄ concentration is controlled at 20%, and siliconizing time is 15 min. A siliconizing rate is increased by optimizing silicon vapor concentration. During the siliconizing process, a unit tension of 4 N/m² is applied to the strip steel to ensure the surface quality of the strip steel and avoid warping or deformation.

The siliconized strip steel is placed in an annealing furnace for diffusion annealing treatment at 1200 °C for 20 min, using nitrogen as a protective gas. The diffusion annealing treatment further homogenizes the gradient distribution of silicon in the strip steel, improves the grain orientation, and optimizes both the magnetic properties and the mechanical properties.

The annealed strip steel is cooled and then detected. The detection results are as follows: composition detection of the strip steel on the surface and in the core using a field emission electron probe gives a surface silicon content of 5.2 wt. % and a core silicon content of 1 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.68 T, and the iron loss (P_{10/50}) is 1.2 W/kg. From the surface silicon content and the core silicon content, it can be seen that a significant gradient distribution of silicon is formed between the surface and the core of the strip steel, thereby obtaining electrical steel with high magnetic induction, low iron loss and gradient distribution of silicon on the surface and in the core.

### Embodiment 3

Original strip steel includes the following main components by mass percentage: 1.5 wt. % of Si+Al, with Si not being 0; 0.001 wt. % of C; 0.3 wt. % of Mn; and the balance being Fe. After cold rolling, original low-carbon low-silicon strip steel is made into strip steel with a thickness of 0.12 mm, with a cold rolling reduction of 88%, ensuring dimensional accuracy and processing properties of the strip steel. An iron matrix in the strip steel exhibits a face-centered cubic structure within a siliconizing temperature range.

The strip steel after cold rolling is rapidly heated to 1130 °C subjected to a siliconizing treatment. During the siliconizing at this temperature, an iron matrix of the strip steel exhibits a face-centered cubic structure. Under a condition corresponding to path 2 shown in FIG. 1, the strip steel is subjected to siliconizing treatment using SiCl₄ as a silicon source and argon as a carrier gas. During the siliconizing process, SiCl₄ concentration is controlled at 20%, and siliconizing time is 15 min. In addition, during the siliconizing process, unit tension of 2 N/m² is applied to the strip steel to ensure siliconizing uniformity and surface integrity and avoid warping or deformation of the strip steel.

The siliconized strip steel is placed into an annealing furnace for diffusion annealing treatment at 1200 °C for 18 min, using nitrogen as a protective gas. Through diffusion annealing treatment, the gradient of silicon content in the strip steel is further adjusted, and the grain orientation is improved, thereby optimizing high magnetic induction and low iron loss properties. The annealed strip steel is cooled and then detected. The detection results are as follows: composition detection of the strip steel on the surface and in the core using a field emission electron probe gives a surface silicon content of 6.3 wt. % and a core silicon content of 1.5 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.65 T, and the iron loss (P_{10/50}) is 1.1 W/kg. From the surface silicon content and the core silicon content, it can be seen that a significant gradient distribution of silicon is formed between the surface and the core of the strip steel, thereby obtaining electrical steel with high magnetic induction, low iron loss and gradient distribution of silicon on the surface and in the core.

### Embodiment 4

Original strip steel includes the following main components by mass percentage: 2 wt. % of Si+Al, with Si not being 0; 0.001 wt. % of C; 0.01 wt. % of Mn; and the balance being Fe. After cold rolling, original low-carbon low-silicon strip steel is made into strip steel with a thickness of 0.20 mm, with a cold rolling reduction of 88%, ensuring dimensional accuracy and processing properties of the strip steel.

The strip steel after cold rolling is rapidly heated to 1180 °C subjected to a siliconizing treatment. During the siliconizing at this temperature, an iron matrix of the strip steel exhibits a face-centered cubic structure. Under a condition corresponding to path 2 shown in FIG. 1, the strip steel is subjected to siliconizing treatment using SiCl₄ as a silicon source and argon as a carrier gas. During the siliconizing process, SiCl₄ concentration is controlled at 20%, and siliconizing time is 18 min. In addition, during the siliconizing process, a unit tension of 2 N/m² is applied to the strip steel to ensure siliconizing uniformity and surface integrity and avoid warping or deformation of the strip steel.

The siliconized strip steel is placed into an annealing furnace for diffusion annealing treatment at 1200 °C for 12 min, using nitrogen as a protective gas. Through diffusion annealing treatment, the gradient of silicon content in the strip steel is further adjusted, and the grain orientation is improved, thereby optimizing high magnetic induction and low iron loss properties.

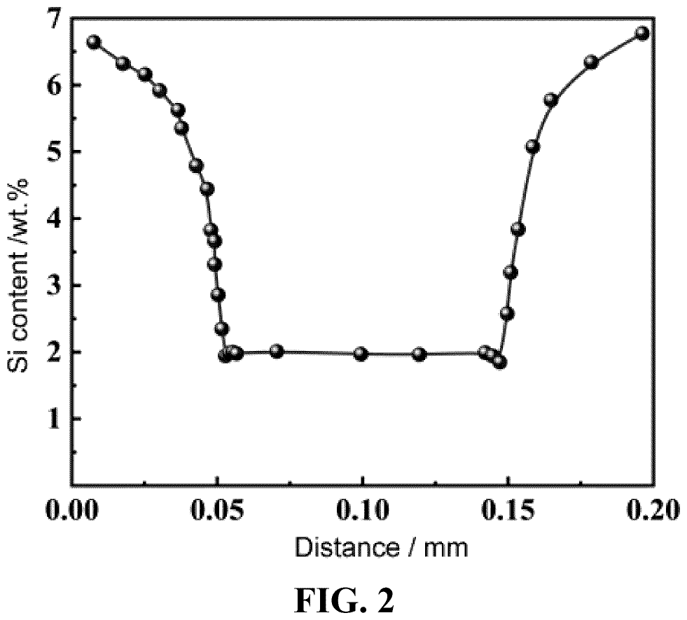

The annealed strip steel is cooled and then detected. The detection results are as follows: composition detection of the strip steel in a thickness direction using a field emission electron probe gives the variation of silicon concentration in the thickness direction (as shown in FIG. 2). It is found that the surface silicon content is 6.8 wt. % and the core silicon content is 2 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.65 T, and the iron loss (P_{10/50}) is 0.98 W/kg. From the surface silicon content and the core silicon content, it can be seen that a significant gradient distribution of silicon is formed between the surface and the core of the strip steel, thereby obtaining electrical steel with high magnetic induction, low iron loss and gradient distribution of silicon on the surface and in the core.

### Embodiment 5

Original strip steel includes the following main components by mass percentage: 1.5 wt. % of Si+Al, with Si not being 0; 0.001 wt. % of C; 0.3 wt. % of Mn; and the balance being Fe. After cold rolling, original low-carbon low-silicon strip steel is made into strip steel with a thickness of 0.12 mm, with a cold rolling reduction of 89%, ensuring dimensional accuracy and processing properties of the strip steel. The strip steel is rapidly heated to 1050 °C for siliconizing treatment, and during siliconizing at this temperature, an iron matrix in the strip steel exhibits a face-centered cubic structure. Under the condition of a path 2 as shown in FIG. 1, the matrix of the strip steel is subjected to siliconizing treatment using SiCl₄ as a silicon source and argon as a carrier gas. During the siliconizing process, SiCl₄ concentration is controlled at 20%, and siliconizing time is 8 min. During the siliconizing process, a unit tension of 2 N/m² is applied to the strip steel to ensure siliconizing uniformity and surface integrity and avoid warping or deformation of the strip steel.

The siliconized strip steel is placed into an annealing furnace for diffusion annealing treatment at 1200 °C for 5 min, using nitrogen as a protective gas. Through diffusion annealing treatment, the gradient of silicon content is further adjusted, and the grain orientation is improved, thereby optimizing high magnetic induction and low iron loss properties.

The annealed strip steel is cooled and then detected. The detection results are as follows: composition detection of the strip steel on the surface and in the core using a field emission electron probe gives a surface silicon content of 6.48 wt. % and a core silicon content of 1.8 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.61 T, and the iron loss (P_{10/50}) is 0.7 W/kg. From the surface silicon content and the core silicon content, it can be seen that a significant gradient distribution of silicon is formed between the surface and the core of the strip steel, thereby obtaining electrical steel with high magnetic induction, low iron loss and gradient distribution of silicon on the surface and in the core.

### Comparative Embodiment 1

Original strip steel includes the following main components by mass percentage: 3.3 wt. % of Si+Al, with Si not being 0; 0.001 wt. % of C; 0.01 wt. % of Mn; and the balance being Fe. After cold rolling, original low-carbon low-silicon strip steel is made into strip steel with a thickness of 0.20 mm, with a cold rolling reduction of 86%, ensuring dimensional accuracy and processing properties of the strip steel.

The strip steel after cold rolling is rapidly heated to 1150 °C subjected to a siliconizing treatment. During the siliconizing at this temperature, an iron matrix of the strip steel exhibits a body-centered cubic structure. Under a condition corresponding to path 1 shown in FIG. 1, the strip steel is subjected to siliconizing treatment using SiCl₄ as a silicon source and argon as a carrier gas. During the siliconizing process, SiCl₄ concentration is controlled at 20%, and siliconizing time is 15 min. In addition, during the siliconizing process, a unit tension of 2 N/m² is applied to the strip steel to ensure siliconizing uniformity and surface integrity and avoid warping or deformation.

The siliconized strip steel is placed into an annealing furnace for diffusion annealing treatment at 1200 °C for 15 min, using nitrogen as a protective gas. Through diffusion annealing treatment, the gradient of silicon content is further adjusted, and the grain orientation is improved, thereby optimizing high magnetic induction and low iron loss properties of the strip steel.

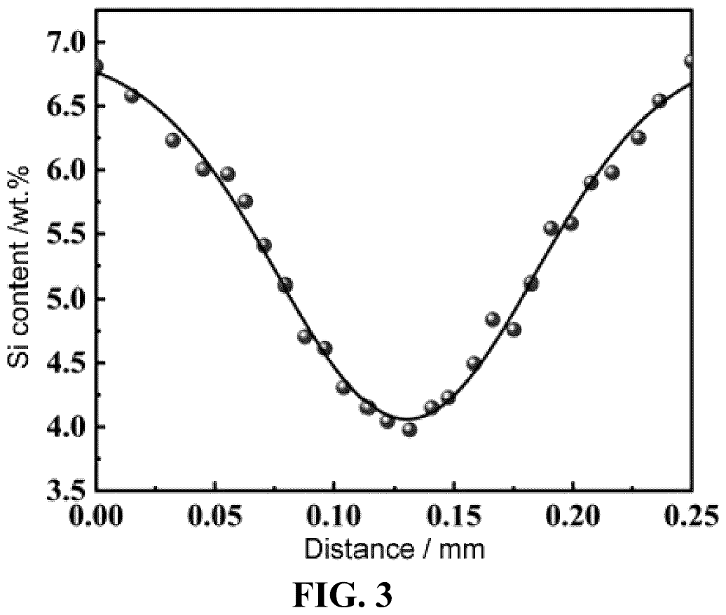

The annealed strip steel is cooled and then detected. The detection results are as follows: composition detection of the strip steel in a thickness direction using a field emission electron probe gives the variation of silicon concentration in the thickness direction (as shown in FIG. 3). It is found that the surface silicon content is 6.8 wt. % and the core silicon content is 4.0 wt. %. According to GB/T 13789-2022, magnetic property detection is performed using a MATS-2010M magnetic property tester. The magnetic induction intensity (B₅₀) is measured at a magnetic field strength of 5000 A/m, and the iron loss (P_{10/50}) is measured at a magnetic flux density of 1.0 T and a frequency of 50 Hz. The magnetic induction intensity (B₅₀) is 1.60 T, and the iron loss (P_{10/50}) is 1.01 W/kg.

From the Comparative Embodiment, it can be seen that when the main compositions and contents of the strip steel fall outside the scope of the present invention, the iron matrix of the strip steel exhibits a body-centered cubic (BCC) structure during the siliconizing process. After siliconizing and diffusion annealing, the core silicon content reaches 4.0 wt. %, and due to the increase in the silicon content, the magnetic induction intensity (B₅₀) is 1.60 T.

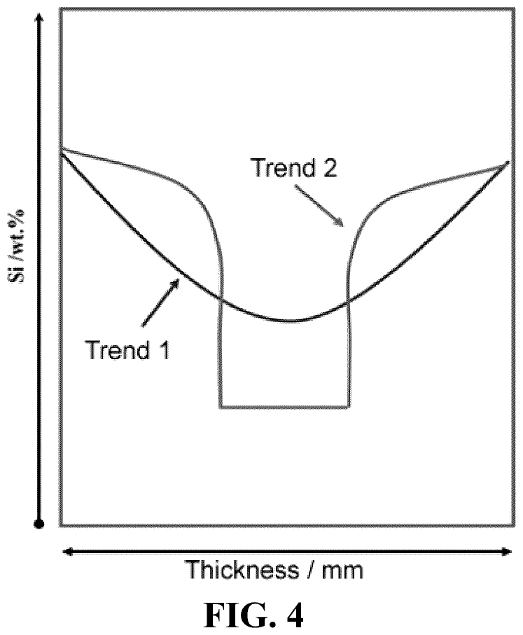

A siliconizing path of Comparative Embodiment 1 is shown as path 1 in FIG. 1. It can be seen that during siliconizing in the path, the initial silicon concentration in the matrix of the strip steel is relatively high. When the siliconizing temperature is reached, the matrix of the strip steel is in a ferrite region (the body-centered cubic structure). A silicon diffusion layer basically covers the entire thickness region, and the silicon content in the core is already much higher than that of the matrix of the original strip steel. The silicon diffusion concentration trend in the path 1 is shown as Trend 1 in FIG. 4. A siliconizing path of Embodiments 1-5 is shown as path 2 in FIG. 1. It can be seen that during siliconizing in the path, the initial silicon concentration of the strip steel is relatively low. When the siliconizing temperature is reached, the matrix of the strip steel is in an austenite region (the face-centered cubic structure). It can be seen from FIG. 2 that Embodiment 4 exhibits a significant gradient distribution of silicon concentration. The thickness of a silicon diffusion layer is about 0.05 mm, and the silicon content of a core matrix of the strip steel is about 2.0 wt. %. The silicon diffusion concentration trend in the path 2 is shown as Trend 2 in FIG. 4. Therefore, by adopting the solution of the present invention to optimize the siliconizing conditions of the strip steel so that the matrix of the strip steel is siliconized in the path 2, the obtained electrical steel exhibits a more significant gradient distribution of silicon concentration, further improving the toughness and processing properties of the material.

What is claimed is:

1. A preparation method for an electrical steel with high magnetic induction, low iron loss and gradient distribution of silicon, comprising the following steps:
performing siliconizing treatment on a strip steel at a temperature of 1050 °C-1200 °C for 5 min-60 min, and after the siliconizing treatment, performing diffusion annealing treatment on the strip steel at a temperature of 980 °C-1200 °C for 5 min-20 min,
wherein by controlling compositions of the strip steel, an iron matrix of the strip steel during a siliconizing process exhibits a face-centered cubic structure, the face-centered cubic structure enables a silicon content on a surface and in a core of the strip steel to exhibit a significant gradient distribution, such that the strip steel after the siliconizing treatment has a surface silicon content of 2.5 wt. %-7.5 wt. % and a core silicon content of 0.1 wt. %-2.0 wt. %, thereby obtaining the electrical steel with high magnetic induction, low iron loss, and gradient distribution of silicon,
wherein the strip steel comprises the following main components by mass percentage: 0.5 wt. %-2.0 wt. % of Si+Al, with Si not being 0; 0.001 wt. %-0.002 wt. % of C; 0.01 wt. %-0.5 wt. % of Mn, and the balance being Fe, and
wherein when a thickness of the strip steel meets required dimensions, the siliconizing treatment is performed directly; and when the thickness of the strip steel is greater than the required dimensions, cold rolling is performed first to achieve the required dimensions, followed by the siliconizing treatment.

2. The preparation method for the electrical steel with high magnetic induction, low iron loss and gradient distribution of silicon according to claim 1, wherein when the thickness of the strip steel is 0.08 mm-0.5 mm, the siliconizing treatment is performed directly, and when the thickness of the strip steel is greater than 0.5 mm, the cold rolling is performed first to achieve the required dimensions, followed by the siliconizing treatment.

3. The preparation method for the electrical steel with high magnetic induction, low iron loss and gradient distribution of silicon according to claim 1, wherein during the siliconizing treatment, SiCl₄ is used as a silicon source, during the siliconizing process, a SiCl₄ vapor concentration is 15%-30%, and argon is used as a carrier gas.

4. The preparation method for the electrical steel with high magnetic induction, low iron loss and gradient distribution of silicon according to claim 1, wherein during the siliconizing process, a unit tension of 1 N/m²-5 N/m² is applied to the strip steel.
